(19) United States
(12) Patent Application Publication
(10) Pub. No.: US 2010/0254607 A1
(43) Pub. Date: Oct. 7, 2010

(54) SYSTEM AND METHOD FOR IMAGE MAPPING AND INTEGRATION

(76) Inventors: Kamal Patel, Paramus, NJ (US); Lior Hod, Teaneck, NJ (US)

Correspondence Address: SEYFARTH SHAW LLP, WORLD TRADE CENTER EAST, TWO SEAPORT LANE, SUITE 300, BOSTON, MA, 02210-2028, US

(21) Appl. No.: 12/417,339

(22) Filed: Apr. 2, 2009

(51) Int. Cl. G06K 9/34

(52) U.S. Cl. 382/180

(57) ABSTRACT

A system and method for data processing and presentation which allows a user to define segments of a digital image, to associate appropriate labels to the defined segments and optionally to link other images to the defined segments is provided. The digital image can be maintained on a server which is accessible by a client-side application over a network such as the Internet. The client-side application according to an illustrative embodiment of the invention includes tools which allow a user to quickly and easily identify boundaries of image segments to which the user can define a label, for example by using a computer mouse to identify vertices of a polygon bounding a selected area. The application can send a definition of the boundaries along with the segment label to a server side application which can store the segment identification information along with the image.

### FIELD OF THE INVENTION

The present invention relates to digital image processing and more particularly to using digital images for input into information processing systems.

### BACKGROUND OF THE INVENTION

Image mapping technologies are used in many applications to combine images and data so that the data can be more easily visualized or selected by a user for processing. For example, well known geographic mapping applications such as Google Earth, by Google Inc. of Mountain View, Calif. involve large databases which link locations in geographical map images to data so that a user can access the data by selecting a hyperlink on a map displayed on the user's computer. Such data might include the name, address and phone number of a business at the selected location, for example. Maintenance and development of such map image databases including adding appropriate links to the image data is generally performed by the image providers, such as Google Inc., rather than the computer user who is the ultimate consumer of the data.

Links that are provided to a user in a digital image may not be well suited to provide certain specific information that the user desires, or to provide the desired data in an easily usable form. It would be desirable for a user to have an ability to define their own image segments and assign links to defined segments. Heretofore known systems and methods which allow users to define image segments, such by using as HTML's image map capability, for example, require the user to develop and/or maintain the image. Use of such systems and methods generally requires relatively advanced computer programming skills. Further, such customized solutions are typically too expensive, too slow or too burdensome for an average business to employ.

### SUMMARY

Illustrative embodiments of the present invention provide a system and method for data processing and presentation which allows a user to define segments of a digital image, to associate appropriate labels to the defined segments and optionally to link other images to the defined segments. The digital image can be maintained on a server which is accessible by a client-side application over a network such as the Internet. The client-side application according to an illustrative embodiment of the invention includes tools which allow a user to quickly and easily identify boundaries of image segments to which the user can define a label, for example by using a computer mouse to identify vertices of a polygon bounding a selected area. The user provides an appropriate label to be associated with the identified image segment. The client-side application can send a definition of the boundaries, e.g., coordinates of the polygon vertices, along with the segment label to a server side application which can store the segment identification information along with the image.

In an illustrative use, when a mouse is placed inside a segment boundary, the label is displayed on an integrated application. When a mouse is clicked inside a selected segment, the segment name is effectively selected for any number of uses, such as input into the integrated application. Optionally, if a selected segment is linked to another image, a server side application can cause the linked image to be displayed on the client side application.

An illustrative embodiment of the invention provides a computer implemented system for mapping data. The system includes a server computer in communication with a computer network. A first digital image representing a physical entity is stored on the server computer. In an illustrative embodiment, the first digital image is a selectable one of a plurality of two-dimensional views of a three-dimensional image, such as an image of a human body, for example, stored on the server computer.

A database on the server system includes user definable image segment boundaries and user definable image segment labels associated with the image segment boundaries. The image segment boundaries can be identified as corners of a user drawn polygon, for example. A processor on the server system is programmed to communicate the first digital image to a user via the computer network and to receive the user definable image segment boundaries and the image segment labels from the user via the computer network. The processor is also programmed to transform the first digital image to include the image segment boundaries and the segment labels.

Illustratively, the database includes a user definable second digital image associated with the user definable segment boundaries. In this embodiment, the processor is programmed to communicate the second digital image to the user via the computer network in response to the processor receiving an indication of a selection by the user of a segment defined by segment boundaries associated with the second digital image. The selection can be made by a user mouse-click on the first digital image within the segment boundaries.

Another illustrative aspect of the invention is a method for providing a user segmentable image. The method includes communicating a first digital image from a server system to a user via a computer network. The first digital image representing a physical entity, such as a human body, for example. User defined image segment boundaries and associated segment labels are received from the user. The image segment boundaries can be identified as corners of a user drawn polygon, for example. The first digital image is transformed on the server system to include the image segment boundaries and the image segment label. Illustratively, the first digital image is stored on the server system. The image segment label can be communicated to a user application in response to receiving an indication of a selection by the user of a segment defined by segment boundaries associated with the image segment label.

Optionally, a user definable second digital image can also be associated with the user definable segment boundaries. The second digital image can be communicated to the user via the computer network in response to receiving an indication of a selection by the user of a segment defined by segment boundaries associated with the second digital image. The selection by a user can illustratively be performed by a user mouse-click on the first digital image within the segment boundaries.

In another illustrative embodiment, the invention provides a method for integrating a mapped image into a user application. The method includes communicating a first digital image from a server system to a user via a computer network. The first digital image representing a physical entity, such as a human body, for example. User defined image segment boundaries are received from the user, by identifying corners of a user drawn polygon, for example. A user defined image segment label is received from the user associated with the image segment boundaries. The first digital image is transformed on the server system to include the image segment boundaries and the image segment label to generate the mapped image. The image segment label can be communicated to a user application in response to receiving an indication of a selection by the user of a segment defined by segment boundaries associated with the image segment label. In an illustrative embodiment, the mapped image can be provided as a web service and/or integrated with the user application.

In a particular embodiment invention, wherein the mapped image includes anatomical images having segments defined in accordance with corresponding anatomical labels, the user application is a medical order form/lab requisition in which fields are filled with the anatomical labels in response to the user selecting the corresponding anatomical image segments by clicking the two dimensional image of the segments.

In another illustrative embodiment, the invention provides a method for integrating a mapped image into a user application. The method includes defining segment boundaries, by the user, on a digital image of a physical object and assigning segment labels, by the user, to corresponding ones of the segment boundaries. Data representing the digital image is transformed by including the segment boundaries and the segment labels in the data to generate the mapped image. The mapped image is integrated with a user application, wherein selection of the image segments on the image causes entry of corresponding segment labels in one or more data fields of the application.

### BRIEF DESCRIPTION OF THE DRAWINGS

The foregoing and other features and advantages of the present invention will be more fully understood from the following detailed description of illustrative embodiments, taken in conjunction with the accompanying drawings in which:

FIG. 1 is a system block diagram of a compute implemented system for mapping data according to an illustrative embodiment of the invention;

FIG. 2 shows an example of a user interface which allows a user to select a two-dimensional image and to define image segment boundaries according to an illustrative embodiment of the invention;

FIG. 3, shows an example of a user interface in which each of a set of arrow buttons can also be linked to separate images by a user according to an illustrative embodiment of the invention;

FIG. 4 is a process flow diagram showing steps of a method for providing a user segmentable image according to an illustrative embodiment of the invention;

FIG. 5 is a process flow diagram showing steps of a method for integrating a mapped image into a user application according to an illustrative embodiment of the invention;

FIG. 6 is a process flow diagram showing steps of a method for integrating a mapped image into a user application according to another illustrative embodiment of the invention;

FIG. 7 shows an example of a user interface in an integrated user application according to an illustrative embodiment of the invention; and

FIG. 8 shows an example of a laboratory requisition form which is automatically generated using an integrated application an illustrative embodiment of the invention.

### DETAILED DESCRIPTION

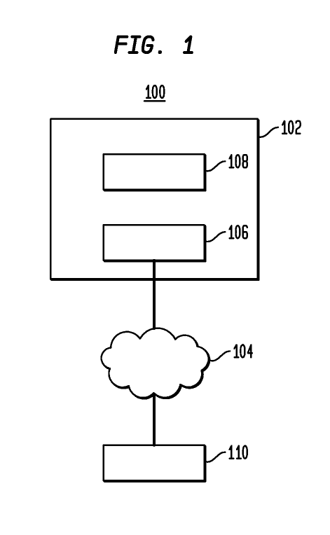

A computer implemented system for mapping data according to an illustrative embodiment of the invention is described with reference to FIG. 1. The system 100 includes a server computer 102 in communication with a computer network 104. The server computer 102 includes a database 106 and a processor 108. A user's computer 110 is in communication with the server computer 102 via the network 104. Although embodiments of the present invention are described herein with reference to a server computer having a processor and a database, persons having ordinary skill in the art should understand that various server configurations may be used, such as server systems having multiple processors or distributed processors and/or databases that are remotely located or distributed on a network, for example, as well as servers that include a local database and processor as shown in FIG. 1.

In the illustrative embodiment, a first digital image representing a physical entity is stored on the server computer 102. The first digital image may be a user selected two dimensional view of a three-dimensional image. For example, a three dimensional digital image of a physical object, such as an image of a human body, may be stored on the server computer 102 and may be accessed by a user computer 110 via the network 104. Software controllable by the user computer 110 may allow the user to manipulate the three dimensional image, by zooming, panning and/or rotating, for example, until a desired view of the three dimensional image is presented to the user. The user may then select a two-dimensional image corresponding to the desired view. Alternatively, a list of selectable two-dimensional images may be presented to the user on a menu, for example.

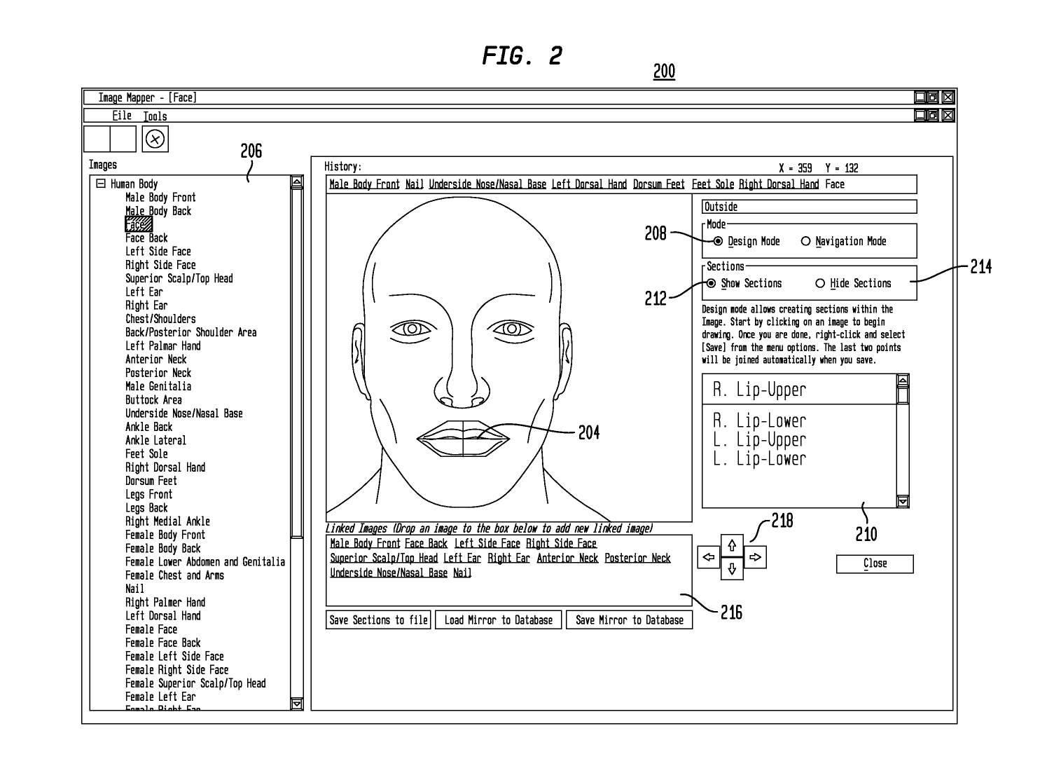

The database 106 on the server computer 102 includes user definable image segment boundaries and user definable image segment labels associated with the image segment boundaries. In an illustrative embodiment, a user interface executable or accessible by the user computer 102 allows the user to view image segment boundaries and to define new image segment boundaries. FIG. 2 shows an example of a user interface 200 according to an illustrative embodiment of the invention which allows a user to select a two-dimensional image 202 and to define image segment boundaries 204. A menu 206 lists available two-dimensional images for user selection. In FIG. 2, the user has selected a two-dimensional image 202 of a human face from the menu 206 of selectable two dimensional images.

The user interface 200 includes a selectable design mode 208 which allows the user to define segment boundaries 204 and to provide segment names 210 for the bounded segments. The segment boundaries may be displayed or hidden on the user interface 200 depending upon whether a “Show Selection” button 212 or a “Hide Selection” button 214 is chosen. When design mode 208 is selected, the use can use a mouse to define image segment boundaries, 204 by clicking on corners of a user drawn polygon in the image. When the segment is drawn, the user can right-click the mouse to save the segment and to provide a new segment label. Once a segment is defined, the segment label is displayed when a mouse hovers over the segment on the two-dimensional image and can be selected as input to another process by clicking on the segment.

In addition to allowing a user to provide new labels for user defined segments and to establish the labels as selectable input to another process, the user interface can also allow a user to link two-dimensional images to the segments. For example, a user can right click on a segment of a first two-dimensional image to activate a menu in which the user can identify a second-two dimensional image for linking to the segment. After such a link has been defined, whenever a user clicks on the segment, whether or not the segment boundaries are displayed, the linked (i.e., second) two-dimensional image is displayed. The second two dimensional image may have all of the functionality of the first two dimensional image in the user interface, thereby allowing the user to define new segments with further links from the second two-dimensional image. In the example user interface 200 shown in FIG. 2, the user may also define a list 216 of two-dimensional images to be linked to the displayed two dimensional image 202. The list 216 may be changed by deleting links or by dragging new image names into the list 216 from the menu 206 of available two-dimensional images. Pan buttons 218 allow a user to navigate around the displayed two-dimensional image.

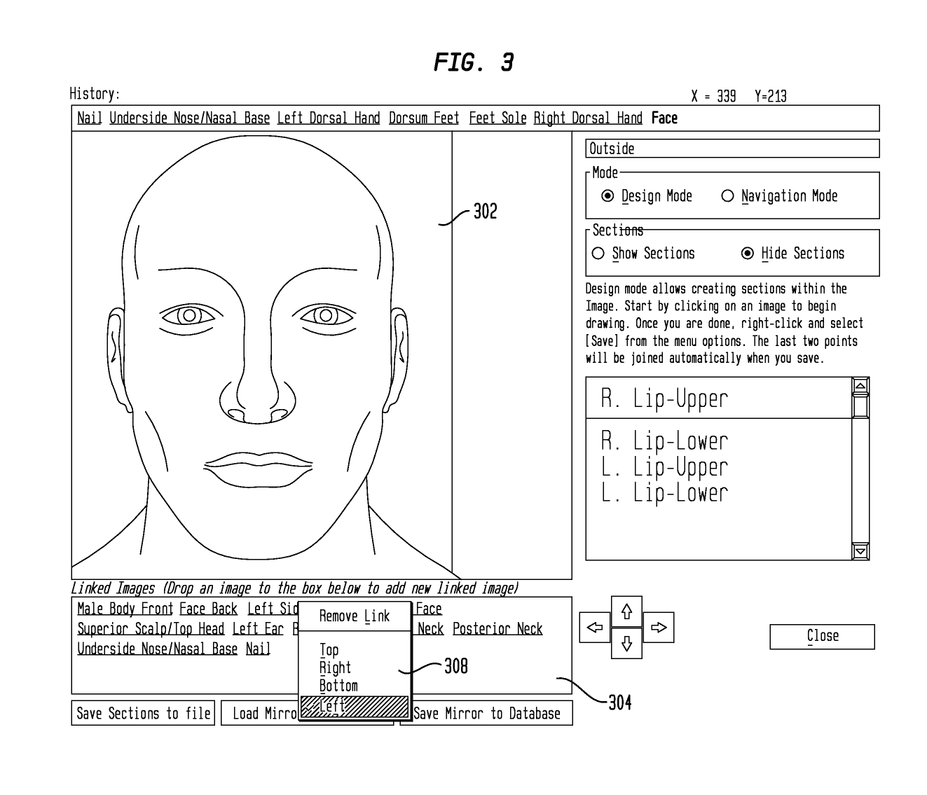

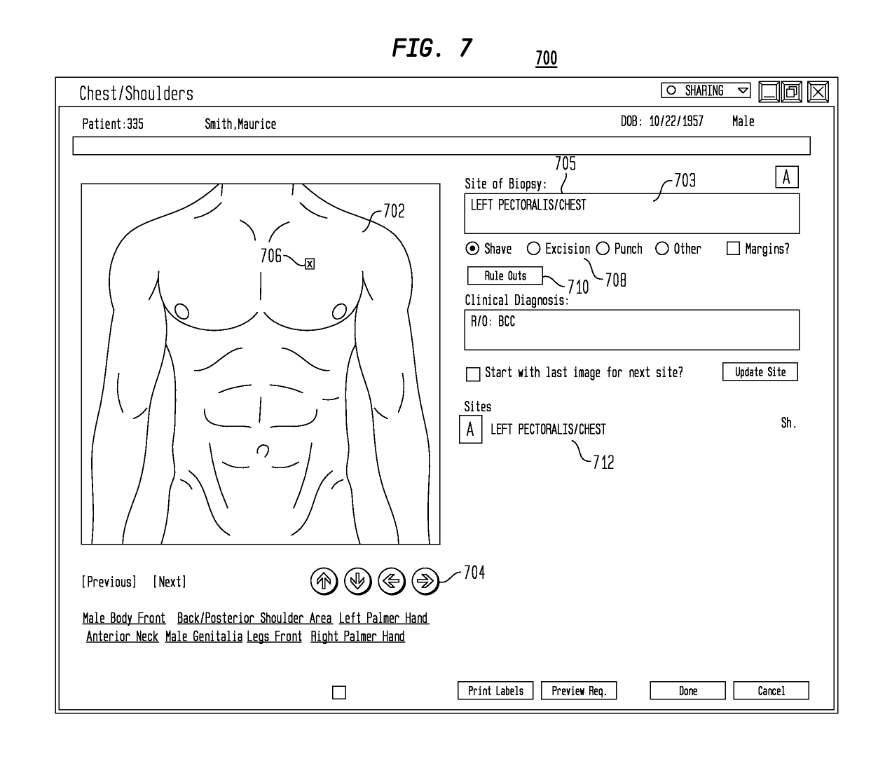

Referring to FIG. 3, each of a set of arrow buttons (not shown) can also be linked to separate images by a user. Such links may also be edited by a user or deleted. For example, when the two dimensional image 302 of a human face is displayed, a user may link another two-dimensional image labeled “left side face” to a left arrow button. In the illustrative embodiment, such links can be established by right clicking on the label “left side face” in link list 304 to display a list 308 of arrow buttons. The user can click the name of the appropriate arrow button to be associated with the “left side face” image when the face image is displayed. Once the link is established, clicking on the a linked arrow button in an application will display the linked image. It should be understood that the arrow button links are context sensitive, in that different links are assigned to the arrow buttons in accordance with the image being displayed. An example of arrow buttons according to an illustrative embodiment of the invention is shown in FIG. 7 within an integrated user application.

Referring again to FIG. 1, the processor 108 on the server computer 102 is programmed to communicate the first digital image to a user computer 110 via the computer network 104 and to receive the user definable image segment boundaries and the image segment labels from the user computer 110 via the computer network 104. The processor 108 is also programmed to transform the first digital image so that it includes the new image segment boundaries and the segment labels defined by the user. The database 106 also includes the user definable digital images that are associated with the user definable segment boundaries. In this embodiment, the processor 108 is programmed to communicate the second digital image to the user computer 110 via the computer network 104 in response to the processor 108 receiving an indication of a selection by the user of a segment defined by segment boundaries associated with the second digital image. The selection can be made by a user mouse-click on the first digital image within the segment boundaries.

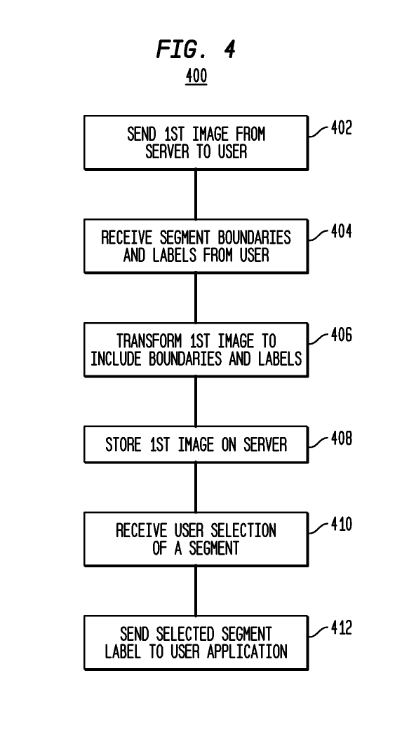

Another illustrative aspect of the invention which includes a method for providing a user segmentable image is described with reference to FIG. 4. According to the illustrative method 400, a first digital image is communicated 402 from a server system to a user via a computer network. The first digital image represents a physical entity, such as a human body, for example. The server system receives 404 user defined image segment boundaries and associated segment labels from the user. The image segment boundaries can be identified as corners of a user drawn polygon, for example. The server system transforms 406 the first digital image so that it includes the image segment boundaries and the image segment label. The first digital image is then stored 408 on the server system. When a user indicates a selection of an image segment 410, for example, by clicking within the boundaries of the image segment, the corresponding image segment label can then be communicated 412 to a user application.

Optionally, a user definable second digital image can also be associated 414 with the user definable segment boundaries. When a user indicates a selection of an image segment having an associated second digital image, the second digital image is communicated 416 to the user via the computer network. The user may then select a segment in the second digital image for communication to the user application.

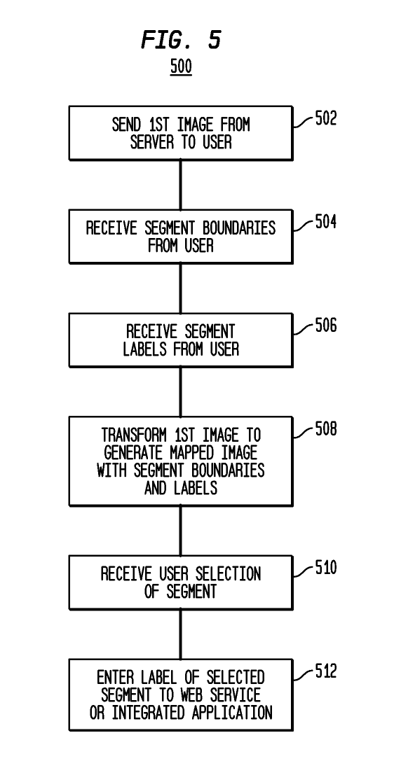

In another illustrative embodiment, described with reference to FIG. 5, the invention provides a method for integrating a mapped image into a user application. The method 500 includes communicating 502 a first digital image from a server system to a user via a computer network. User defined image segment boundaries are received 504 from the user, by identifying corners of a user drawn polygon, for example. A user defined image segment label associated with the image segment boundaries is received 506 from the user. The first digital image is transformed 508 on the server system so that it includes the image segment boundaries and the image segment labels thereby generating a mapped image. An indication of a selection by the user of a segment defined by segment boundaries associated with the image segment label is received from the user 510. The image segment labels are communicated 512 to a user application in response to receiving the indicated selection. The mapped image can be provided as a web service and/or integrated with the user application.

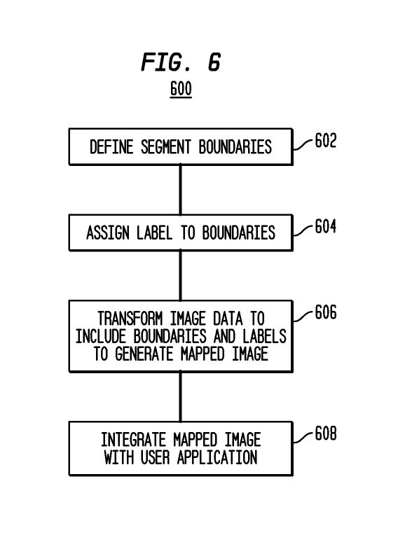

Another illustrative embodiment of the invention providing a method for integrating a mapped image into a user application is described with reference to FIG. 6. The method 600 includes defining segment boundaries 602, by the user, on a digital image of a physical object. The user also assigns segment labels 604 to corresponding segment boundaries. Data representing the digital image is transformed 606 by including the segment boundaries and the segment labels in the data to generate the mapped image. The mapped image is integrated 608 with a user application, wherein selection of the image segments on the image causes entry of corresponding segment labels in one or more data fields of the application.

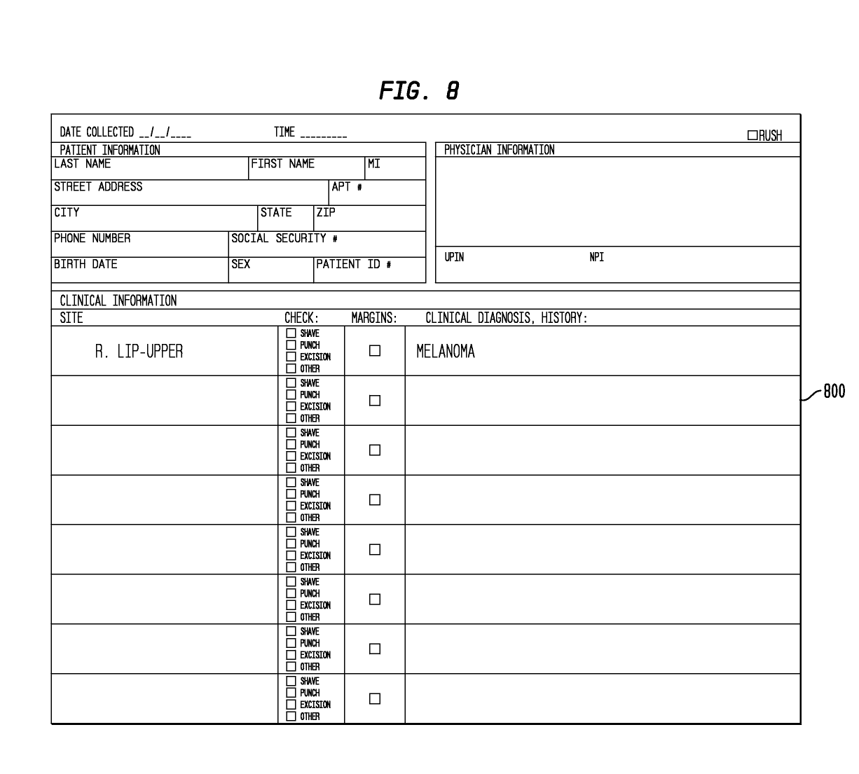

An example of a user interface in an integrated user application according to an illustrative embodiment of the invention is shown in FIG. 7. In this example, the user interface 700 includes a mapped image 702 representing portions of a human body having segments defined in accordance with corresponding anatomical labels. The user application in this example is a medical order form/lab requisition in which fields 703 are filled with the anatomical labels in response to the user selecting the corresponding anatomical image segments by moving a curser 706 over the desired segment and clicking on the mapped image 702. Once a label 705 is entered into the input field 703, here indicating the site of a biopsy, the integrated application accepts other information, such as the type of biopsy 708 and conditions to be ruled out 710 by lab tests to be performed on the biopsy. Biopsy sites to be included in the order/requisition are automatically added to a list 712 on the user interface 700. Arrow buttons 704 are linked to related images to allow input related to other views of the human body. The arrow buttons 704 may be configured by users in a design mode as described herein with reference to FIG. 3, for example. When the user finishes inputting data into the form, a corresponding test order or lab requisition 800 is automatically generated (FIG. 8).

While the invention has been described with reference to illustrative embodiments, it will be understood by those skilled in the art that various other changes, omissions, and/or additions may be made and substantial equivalents may be substituted for elements thereof with departing from the spirit and scope of the invention. In addition, many modifications may be made to adapt a particular situation or material to the teaching of the invention with departing from the scope thereof. Therefore, it is intended that the invention not be limited to the particular embodiment disclosed for carrying out this invention, but that the invention will include all embodiments, falling within the scope of the appended claims. Moreover, unless specifically stated any use of the terms first, second, etc., do not denote any order of importance, but rather the terms first, second, etc. are used to distinguish one element from another.

1. A computer implemented system for mapping data, the system comprising:
a server computer in communication with a computer network;
a first digital image stored on the server computer, the first digital image representing a physical entity;
a database on the server system, the database including user definable image segment boundaries and user definable image segment labels associated with said image segment boundaries; and
a processor on the server system programmed to communicate the first digital image to a user via the computer network and to receive said user definable image segment boundaries and said image segment labels from said user via said computer network, said processor being programmed to transform said first digital image to include said image segment boundaries and said segment labels.

2. The computer implemented system of claim 1:
wherein said database includes a user definable second digital image associated with said user definable segment boundaries.

3. The computer implemented system of claim 2:
wherein said processor is programmed to communicate said second digital image to said user via the computer network in response to the processor receiving an indication of a selection by said user of a segment defined by segment boundaries associated with the second digital image.

4. The computer implemented system of claim 3:
wherein said selection is a mouse-click on said first digital image within said segment boundaries by said user.

5. The computer implemented system of claim 1:
wherein said first digital image is a selectable one of a plurality of 2-dimensional views of a 3-dimensional image stored on said server computer.

6. The computer implemented system of claim 1:
wherein said physical entity is a human body.

7. A method for providing a user segmentable image the method comprising:
communicating a first digital image from a server system to a user via a computer network, the first digital image representing a physical entity;
receiving user defined image segment boundaries from said user;
receiving a user defined image segment label associated with said image segment boundaries from said user; and
transforming said first digital image on said server system to include said image segment boundaries and said image segment label.

8. The method of claim 7, comprising:
storing said first digital image on said server system.

9. The method of claim 7:
wherein said first digital image is a selectable one of a plurality of 2-dimensional views of a 3-dimensional image stored on said server system.

10. The method of claim 7, comprising:
associating on said server system a user definable second digital image with said user definable segment boundaries.

11. The method of claim 10, comprising:
communicating a second digital image to said user via the computer network in response to receiving an indication of a selection by said user of a segment defined by segment boundaries associated with the second digital image.

12. The method of claim 7, comprising:
communicating said image segment label to a user application in response to receiving an indication of a selection by said user of a segment defined by segment boundaries associated with the image segment label.

13. The method of claim 11 or 12, wherein said selection is a mouse-click on said first digital image within said segment boundaries by said user.

14. The method of claim 7, wherein said first digital image represents a human body.

15. The method of claim 7,
wherein said image segment boundaries are identified as corners of a user drawn polygon.

16. A method for integrating a mapped image into a user application, comprising:
communicating a first digital image from a server system to a user via a computer network, the first digital image representing a physical entity;
receiving user defined image segment boundaries from said user;
receiving a user defined image segment label associated with said image segment boundaries from said user;
transforming said first digital image on said server system to include said image segment boundaries and said image segment label to generate said mapped image;
communicating said image segment label to a user application in response to receiving an indication of a selection by said user of a segment defined by segment boundaries associated with the image segment label.

17. The method of claim 16, further comprising:
integrating said mapped image with said user application.

18. The method of claim 17, wherein said mapped image includes anatomical images having segments defined in accordance with corresponding anatomical labels.

19. The method of claim 18, wherein said application is a medical order form in which fields are filled with said anatomical labels in response to said user selecting said corresponding anatomical image segments.

20. The method of claim 18, wherein said application is a medical laboratory requisition.

21. A method for integrating a mapped image into a user application, comprising:
defining segment boundaries, by said user, on a digital image of a physical object;
assigning segment labels, by said user, to corresponding ones of said segment boundaries:
transforming data representing said digital image by including said segment boundaries and said segment labels in said data to generate said mapped image; and
integrating said mapped image with a user application, wherein selection of said image segments on said image causes entry of corresponding segment labels in one or more data fields of said application.

22. The method of claim 21, wherein said mapped image includes anatomical images having segments defined in accordance with corresponding anatomical labels.

23. The method of claim 22, wherein said application is a medical order form in which said fields are filled with said anatomical labels in response to said user selecting said corresponding anatomical image segments by a mouse click within said segment boundaries on said image.
